(19) United States
(12) Patent Application Publication
(10) Pub. No.: US 2026/0240295 A1
(43) Pub. Date: Aug. 20, 2026

(54) Mobile Phone Holder

(71) Applicant: Kurt Gerlitz, Brandon, FL (US)

(72) Inventor: Kurt Gerlitz, Brandon, FL (US)

(21) Appl. No.: 19/057,903

(22) Filed: Feb. 19, 2025

(51) Int. Cl. A45C 11/00; F16M 13/02

(52) U.S. Cl. CPC A45C 11/002; F16M 13/02

(57) ABSTRACT

A mobile phone holder that comprises a receptacle or pouch for the mobile phone that is attached to a wall or other structure and which has a pull cord attached so that if a user slips or falls the user can pull on the pull cord and retrieve the mobile phone to contact and request assistance.

### FIELD OF THE INVENTION

The invention relates to a mobile phone holder for emergency access.

### BACKGROUND OF THE INVENTION

Mobile telephones or phones have in many situations significantly benefitted users with respect to the ability to make calls for assistance, including for emergency services. However, there are certain times when a user can be in a situation that is more dangerous than others without having ready access to their mobile phone (e.g., a person taking a shower or a bath who may be subject to dizziness or slipping and/or falling). Having better access to a mobile phone in such situations would be highly beneficial and in some cases life-saving.

### SUMMARY OF THE INVENTION

Embodiments of this invention provide a mobile phone holder that can be made accessible to a user during particular activities and in which the user can place their mobile phone. The user can have access to the mobile phone by pulling a cord attached to the mobile phone holder to obtain the mobile phone holder and the mobile phone and then make any needed calls or otherwise use the mobile phone.

Preferred embodiments of the mobile phone holder comprise a receptacle (also referred to herein as a pouch) for containing a mobile phone, the pouch comprising a top access flap that can close the pouch, attachment hardware connected to the pouch for removably attaching and detaching the pouch to a wall or other structure or place, and a pull cord connected to the pouch for detaching the pouch from the wall and retrieving the pouch and the mobile phone it contains when the mobile phone is needed.

Advantages of the embodiments of this invention are described and apparent throughout this specification. For example, certain embodiments of the mobile phone holder of this invention can be placed next to a shower on the wall, away from the water flow, in a bathroom. If the user slips and/or falls while taking a shower, or otherwise needs assistance, the user can pull the pull cord connected to the mobile phone holder and draw the mobile phone closer and then contact someone (e.g., emergency services such as police, fire or ambulance or an assistant or family member) for assistance. Further advantages will be apparent to a person of skill in the art applying the embodiments of the invention.

### BRIEF DESCRIPTION OF THE DRAWINGS

FIG. 1 is a front view of a mobile phone holder embodiment of this invention as it would appear hanging on a wall and ready for use, showing a portion of a pull cord.

FIG. 2 is a front view of a mobile phone holder embodiment of this invention with the top access flap open, showing a portion of a pull cord.

FIG. 3 is a rear view of a mobile phone holder embodiment of this invention, showing a portion of a pull cord.

### DETAILED DESCRIPTION OF THE INVENTION

The invention provides a mobile phone holder comprised of several components. The components may comprise a pouch for containing a mobile phone. The pouch may comprise a top access flap that can close the pouch and thereby enclose a mobile phone contained inside. The mobile phone holder may also comprise attachment hardware connected to the pouch for removably attaching and detaching the pouch to a wall or other structure or place. The mobile phone holder may also comprise a pull cord that is long enough to be accessible to a user. The pull cord may have a proximal end that is attached to the pouch, and a distal end that is away from the pouch. The pull cord may be used to pull on in order to pull the pouch containing a mobile phone closer to the user. If the mobile phone holder is attached to a wall or other structure or location with the attachment hardware, pulling on the distal end of the pull cord may pull the mobile phone holder off of the wall and bring the pouch portion containing the mobile phone closer to the user. The user can then retrieve the mobile phone and make a call or otherwise use the mobile phone if needed.

Preferred embodiments of the pouch of this invention are large enough to hold a mobile phone. Various sizes may be made available to fit different sizes of mobile phones in some embodiments, although in other embodiments a single size is available that fits all or most mobile phones. One set of preferred embodiments comprises a pouch that is 5" wide by 8" tall with a 3" top access flap, although other sizes can be used. In some embodiments, the top access flap is in a general rectangular shape (e.g., square, rectangle, trapezoid) or other shape to close the pouch, although other sizes and shapes can be used. While the word "pouch" is used herein, the term should be applied broadly to describe any shape or receptacle that can generally contain a mobile phone. The pouch may be flexible or rigid. It may have distinct walls or have no seams or walls at all (e.g., like a bag or sack).

Certain embodiments of the pouch of this invention comprise one or more materials that are used for the walls or sides or body of the pouch. These materials may be fabric, plastics, natural materials, etc., or combinations of such. They can be water proof or water resistant in some embodiments. The pouch may also comprise padding or material that otherwise provides protection to the mobile phone against drops. The materials may be held together by thread, glue, hardware, and other hardware and methods known to a person of skill in the art.

The pouch may comprise closure hardware in some embodiments, which is used to close the top access flap. In some preferred embodiments, this closure hardware comprises hook and loop (also known as Velcro) fasteners with one part on the front of the pouch and another part on the inside of the top access flap so that when the flap is closed the two parts meet and the pouch stays closed until opened again. Other fasteners can be used (e.g., magnetic, snaps, etc.), as will be known to a person skilled in the art.

The mobile phone holder may also comprise attachment hardware connected to the pouch and a wall or other desired structure or location for the mobile phone holder. In preferred embodiments, this attachment hardware comprises hook and loop (also known as Velcro) fasteners with one part on the back of the pouch and another part installed on the wall in a desired location for the mobile phone holder (e.g., a strip of one part of 3/4" hook and loop fastener attached to the wall (e.g., with adhesive, screws, etc.) and a matching size of the opposite part of 3/4" hook and loop fastener on the back of the pouch). Other fasteners can be used (e.g., magnetic, snaps, etc.), as will be known to a person skilled in the art. However, it is important that the attachment hardware be removable so that in operation, when the pull cord is pulled by the user, the mobile phone holder will detach from the wall and the attachment hardware (or half of the hardware) so it can be retrieved by the user.

The mobile phone holder may also comprise a pull cord. In preferred embodiments one end of the pull cord is attached to the pouch (e.g., by sewing, gluing, hardware, etc.). In the most preferred embodiments, the pull cord is attached to the back of the pouch, but it is wrapped around the front of the pouch where it is held in place on the front of the pouch by a pull cord keeper such as a loop of material (e.g., cord, ribbon, fabric, etc.) through which it passes.

This pull cord can comprise a string, rope, twisted strands or fibers, wire, chain, ribbon, fabric, combinations of such or other material or hardware that can act like a cord so that when the distal end of the pull cord is pulled, tension is transferred to the proximal end attached to the pouch. The pull cord should be long enough that it may be reachable by a user in need. In some embodiments, the pull cord may be shortened or added to according to the application of where and how it will be used. In some preferred embodiments, the length of the pull cord is adjustable.

One set of preferred embodiments uses a flat pull cord that is a fabric ribbon and is 36" long by %" wide and it is attached to the top back of a pouch, brought forward over the top of the pouch, kept in place on the front of the pouch by a pull cord keeper (e.g., loop of fabric, thread, or other material), through which it is inserted, and then draped or otherwise brought to the edge of a bathtub or shower or other location so that the distal end of the cord is long enough to be accessible to a user who may need to retrieve the mobile phone. In certain embodiments, the length of the pull cord is adjustable. In other embodiments, the length of the pull cord can be added to by adding additional material.

This invention also provides a method for storing a mobile phone holder so that it can be retrieved if needed. In this method, the mobile phone holder permits the storage and the retrieval of the mobile phone. The mobile phone holder can be attached to a wall with attachment hardware (e.g., hook and loop fasteners). The top access flap of the pouch may be opened and a mobile phone placed inside the pouch, and then the top access flap may be closed. The pull cord can be brought from the back of the pouch where it may be attached, over the top of the pouch, and placed on the front of pouch and be held in place by a pull cord keeper on the front of the pouch. The distal end of the pull cord may then be placed where it may be accessed by a user if needed. Other arrangements of the pull cord are also possible in other embodiments.

The pull cord may be used to pull on in order to pull the pouch containing a mobile phone closer to the user. If the mobile phone holder is attached to a wall with the attachment hardware, pulling on the pull cord may pull the mobile phone holder off of the wall and the attachment hardware and bring the pouch portion containing the mobile phone closer to the user. The user can then retrieve the mobile phone and make a call or otherwise use the mobile phone if it is needed.

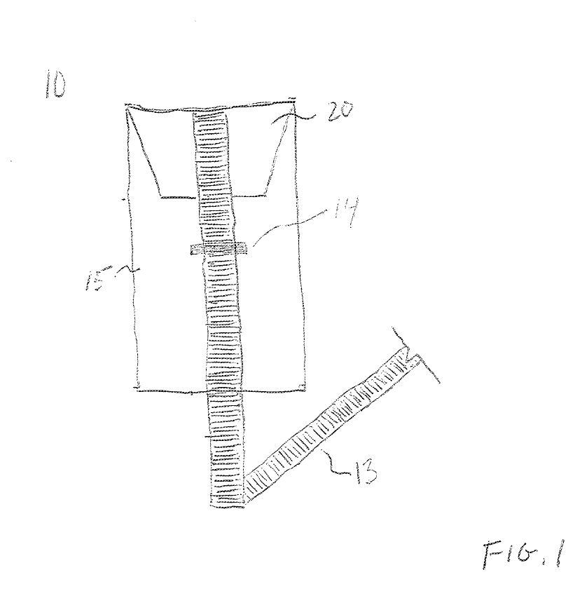

FIG. 1 is a front view of a mobile phone holder 10 embodiment of this invention as it would appear hanging on a wall and ready for use, showing a portion of a pull cord 13 held in place by a pull cord keeper 14. The mobile phone holder 10 is large enough to contain a desired mobile phone in a pouch 15. The mobile phone holder has a top access flap 20, that is shown closed here, but which can be opened by lifting it up in order to place (or remove) a mobile phone inside the pouch 15.

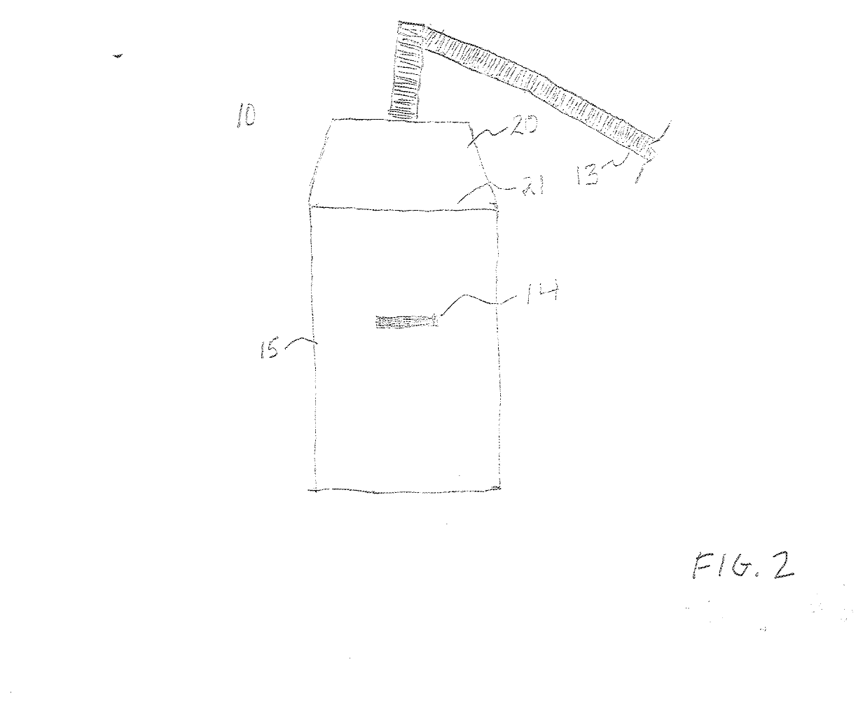

FIG. 2 is a front view of a mobile phone holder 10 embodiment of this invention with the top access flap 20 open, showing where there will be an opening 21 in which a mobile phone can be inserted in the pouch 15. A portion of a pull cord 13 is also shown and when in use, the top access flap 20 will be closed and the pull cord 13 will be put through the pull cord keeper 14.

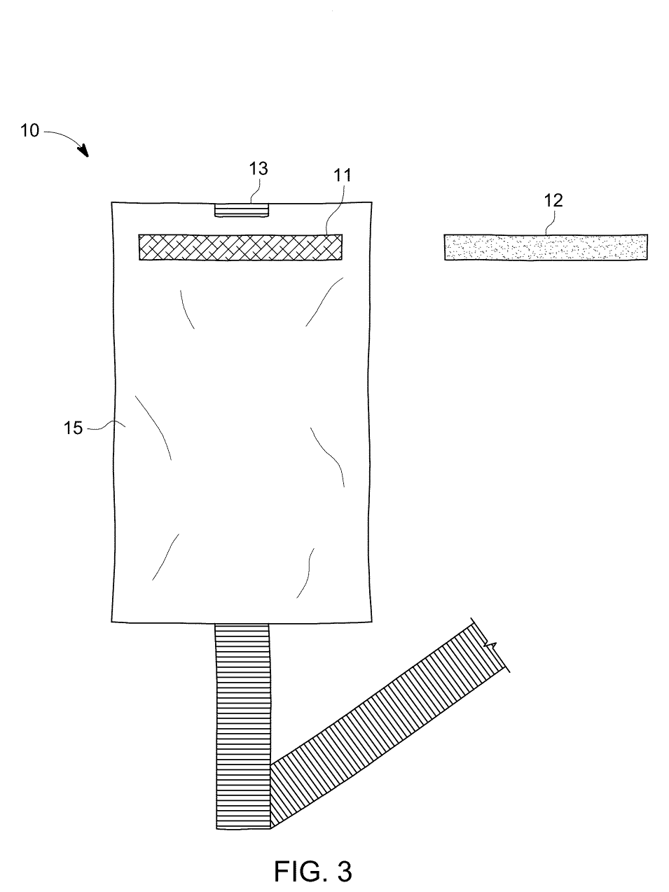

FIG. 3 is a rear view of a mobile phone holder 10 embodiment of this invention. The mobile phone holder 10 is large enough to contain a desired mobile phone. It can be held on a wall or other structure by attachment hardware, such as a two part hook and loop (Velcro) fastener, with one part of the fastener 11 attached to the mobile phone holder pouch 15, and the other part of the fastener 12 attached to a wall or other structure (by adhesives, screws, etc.). The pull cord 13 of the mobile phone holder may be attached to the rear of the mobile phone holder 10.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A mobile phone holder for storing and retrieving a mobile phone by a user, which mobile phone holder is attached to a structure, and which mobile phone holder holds the mobile phone, the mobile phone holder comprising:a. a pouch in which the mobile phone can be placed, the pouch comprising a top access flap that when opened can allow the mobile phone to be placed inside the pouch for storing the mobile phone;b. attachment hardware for removably attaching and detaching the pouch to the structure;c. a pull cord with a proximal and a distal end, the proximal end of the pull cord being attached to the pouch and the distal end being accessible to the user; andd. wherein if the pouch is attached to the structure and it contains the mobile phone, when the user pulls on the pull cord, the attachment hardware detaches the pouch from the structure and the user can retrieve the mobile phone from the pouch.

2. The mobile phone holder of claim 1 wherein the structure is a bathroom wall.

3. The mobile phone holder of claim 1 wherein the pull cord is kept in place on the pouch by a pull cord keeper and wherein the pull cord keeper is attached to the pouch.

4. The mobile phone holder of claim 1 wherein the pull cord comprises a Mz" wide ribbon.

5. A method for a user storing and retrieving a mobile phone, the method comprising:a. storing the mobile phone in a pouch of a mobile phone holder by placing the mobile phone in the pouch by opening a top access flap in the pouch and putting the mobile phone inside the pouch;b. removably attaching the pouch containing the mobile phone to a structure;c. retrieving the mobile phone by detaching the pouch containing the mobile phone from the structure by pulling on a pull cord that is attached to the pouch.

6. The method of claim 5 wherein the structure is a bathroom wall.

7. The method of claim 5 wherein the pull cord is kept in place on the pouch by a pull cord keeper and wherein the pull cord keeper is attached to the pouch.

8. The method of claim 5 wherein the pull cord comprises a %" wide ribbon.
